(19) United States
(12) Patent Application Publication
(10) Pub. No.: US 2021/0056207 A1
(43) Pub. Date: Feb. 25, 2021

(54) Securing Devices From Unauthorized Software Upgrade

(71) Applicant: QUALCOMM Incorporated, San Diego, CA (US)

(72) Inventors: Prakash TIWARI, Hyderabad (IN); Rajashankar Varaprasad KATKAM, Hyderabad (IN); Naga Chandan Babu GUDIVADA, Hyderabad (IN); Ashalatha PRATHAPANENI, Hyderabad (IN)

(21) Appl. No.: 16/546,750

(22) Filed: Aug. 21, 2019

(51) Int. Cl. G06F 21/57; G06F 21/44; G06F 21/60; G06F 9/4401; G06F 8/65

(52) U.S. Cl. CPC G06F 21/572; G06F 21/575; G06F 21/44; G06F 2221/033; G06F 9/4406; G06F 8/65; G06F 21/602

(57) ABSTRACT

A mobile device may be configured to monitor its systems and subsystems to detect a flashing command from a flashing tool or source, generate and store a flashing request value in a secure area of the mobile device in response to detecting the flashing command, send the flashing request value to the flashing tool or source, and send a notification message to a server computing device of a trusted entity. In response, the mobile device may receive a notification-response message that includes a secured flashing request value from the server computing device, and determine whether the secured flashing request value matches the flashing request value stored in the secure area of the mobile device. The mobile device may ignore or discard the detected flashing command in response to determining that the secured flashing request value does not match the flashing request value stored in the secure area.

### BACKGROUND

Flashing tools, over-the-air software updates, and other new and emerging technologies now allow mobile device users to erase and/or reprogram the non-volatile memories in their mobile devices with relative ease. Criminals and nefarious actors may use these technologies to gain unauthorized control or access over a mobile device. For example, a criminal may purchase a subsidy locked mobile device at a significant discount, and use a flashing tool (e.g., Ultimate Multi tool, QC Fire tool, etc.) to erase its non-volatile memories and load an unauthorized and/or unauthenticated software image on mobile device. The software image may remove or overwrite the subsidy lock on the mobile device without authorization or approval from the lender, device manufacturer or network service provider, allowing the criminal to cease making payments to the lender and/or to sell the unlocked device at a significant markup in price.

### SUMMARY

Various aspects of the disclosure provide methods of operating a mobile device, which may include collecting, by a processor in the mobile device, flashing information, storing, by the processor, the collected flashing information in a secure area of the mobile device, evaluating, by the processor on each reboot of the mobile device, flashing information stored in the secure area of the mobile device and information stored in a secured action-command information structure to generate an evaluation result, selectively setting, by the processor based on the evaluation result, a tampered flag or bit in the secure area of the mobile device, and performing, by the processor, a responsive actuation operation in response to determining that the tampered flag or bit has been set.

In some aspects, collecting flashing information may include at least one or more of collecting flashing information in response to detecting an erase command in a boot sequence, collecting flashing information in response to detecting a program command in the boot sequence, collecting flashing information in response to detecting a software update image from an over-the-air update server, or collecting flashing information in response to determining that a primary bootloader (PBL) of a secure boot feature of the mobile device failed to verify a secondary bootloader (SBL) and the mobile device has commenced entering emergency download mode (EDL).

In some aspects, collecting flashing information may include collecting at least one or more of flashing source information identifying a flashing source, information identifying a command issued by the flashing source, information identifying an action performed by the mobile device in response to the command issued by the flashing source, a result generated in the mobile device from performance of the command issued by the flashing source, or a number of times that flashing operations have been detected on the mobile device over a period of time.

In some aspects, the secured action-command information structure may store values hashed with an International Mobile Equipment Identity (IMEI) number or a hardware key (HW key) in an instruction memory or another secure area of the mobile device. In some aspects, evaluating, on each reboot of the mobile device, flashing information stored in the secure area of the mobile device and information stored in the secured action-command information structure to generate the evaluation result may include comparing flashing information stored in the secure area of the mobile device with a value hashed with the IMEI number or the HW key in the instruction memory or other secure area of the mobile device.

In some aspects, evaluating, on each reboot of the mobile device, flashing information stored in the secure area of the mobile device and information stored in the secured action-command information structure to generate the evaluation result may include comparing, on each reboot, flashing information stored in the secure area with the information stored in the secured action-command information structure to determine whether flashing operations completed most recently were non-benign.

In some aspects, storing the collected flashing information in the secure area of the mobile device may include incrementing a flashing counter in the secure area of the mobile device that identifies a number of times that flashing operations have been detected on the mobile device. Some aspects may further include determining, by the processor based on the evaluation result, a probability value that identifies a likelihood that a detected flashing operation is an unauthorized flashing operation, and determining, by the processor, whether the probability value exceeds a threshold value, in which selectively setting the tampered flag or bit in the secure area of the mobile device may include setting, by the processor, the tampered flag or bit in the secure area of the mobile device in response to determining that the probability value exceeds the threshold value.

In some aspects, determining the probability value that identifies the likelihood that the detected flashing operation is an unauthorized flashing operation may include determining, based on the evaluation result, whether an International Mobile Equipment Identity (IMEI) number, subsidy lock or security critical information was erased from the mobile device. Some aspects may include setting the probability value greater than the threshold value in response to determining that the IMEI number, subsidy lock or security critical information was erased from the mobile device.

In some aspects, determining the probability value that identifies the likelihood that the detected flashing operation is the unauthorized flashing operation may include determining the probability value based on a number of times that flashing operations have been detected on the mobile device. In some aspects, storing the collected flashing information in the secure area of the mobile device may include storing flash control information in the secure area during a first bootup of the mobile device, when secure boot is enabled, or during provisioning of secure areas of the mobile device.

Further aspects may include a mobile device including a processor configured with processor-executable instructions to perform operations of any of the methods summarized above. Further aspects may include a non-transitory processor-readable storage medium having stored thereon processor-executable software instructions configured to cause a processor in a mobile device to perform operations of any of the methods summarized above. Further aspects may include a mobile device having various means for accomplishing the functions of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1A is a block diagram illustrating an example 5G system in a package (SIP) in a mobile device that is suitable for implementing progressively more stringent restrictions on the usage of the mobile device in accordance with some embodiments.

FIG. 1B is a block diagram illustrating an example system suitable for implement a method of identifying and responding to suspicious and non-benign reprogramming operations on a mobile device in accordance with some embodiments.

FIG. 1C is a block diagram illustrating an example system suitable for implement a method in which a mobile device works in conjunction with a server computing device and an authorized flashing tool/source to ensure that flashing operations detected on the mobile device are authorized by a trusted entity before the detected flashing operations are loaded or executed by the mobile device in accordance with some embodiments.

FIGS. 2A through 2D are process flow diagrams illustrating methods in which a mobile device works in conjunction with a server computing device and an authorized flashing tool/source to ensure that flashing operations detected on the mobile device are authorized by a trusted entity before the detected flashing operations are loaded or executed by the mobile device in accordance with some embodiments.

FIGS. 3A through 3C are process flow diagrams illustrating methods of identifying and responding to suspicious and non-benign reprogramming operations on a mobile device in accordance with some embodiments.

FIG. 4 is block diagram illustrating example logical and functional components in a mobile device that includes secure and non-secure protection domains suitable for identifying and responding to suspicious and non-benign reprogramming operations in accordance with some embodiments.

FIGS. 5A through 5E are block diagrams that illustrate example logical components and information flows in secure computing environments that could be included in a mobile device and used to identify and respond to suspicious and non-benign reprogramming operations in accordance with some embodiments.

FIG. 6 is a component block diagram of mobile device suitable for implementing the various embodiments.

FIG. 7 is a component block diagram of server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and mobile devices configured to implement the methods, for identifying and responding to suspicious or non-benign reprogramming operations on a mobile device, particularly flash memory operations that could erase and/or reprogram the mobile device, such as to remove the mobile device's subsidy locks without prior authorization or approval from the lender, device manufacturer or network service provider. various embodiments may prevent criminals and nefarious actors from circumventing existing security features of the mobile device (e.g., secure boot, etc.) to install, load or execute an unauthorized or unauthenticated software image on the mobile device (e.g., to remove its subsidy lock, etc.).

In some embodiments, a mobile device may be configured to monitor various systems and subsystems in the mobile device to detect flashing operations (e.g., operations initiated by a flashing tool, reprogramming operations initiated by a bootloader, etc.). In response to detecting flashing operations, the mobile device may collect and store flashing information in a secure area of the mobile device. The term “flashing information” is used herein to refer to any information related to or used by a flash tool or reprogramming operations initiated by a bootloader, including, but not limited to, flashing source information (e.g., a flashing source identifier), information identifying commands issued by the flashing source, information identifying an action performed by the mobile device in response to the issued command, a result generated in the mobile device from the performance of the issued command, a number of times that flashing operations have been detected or performed over a period of time, and/or actions performed by the mobile device in response to an issued command

On each reboot, a processor of the mobile device may evaluate or compare flashing information stored in the secure areas of the mobile device with the information stored in a secured action-command information structure (e.g., a table, map, database, etc.). Based on the result of this evaluation/comparison, the mobile device processor may take an action to protect against unauthorized or non-benign flashing operations. In some embodiments, the mobile device processor may determine a probability or likelihood that the detected flashing operations are unauthorized or otherwise non-benign based on the evaluation/comparison. For example, if the results of the evaluation/comparison indicate that an International Mobile Equipment Identity (IMEI) number, subsidy lock or security critical information was erased from the mobile device, the mobile device processor may determine that there is a high probability (e.g., 95% probability, etc.) that the detected flashing operations are unauthorized or non-benign. If the determined probability exceeds a threshold value (e.g., 49%, 51%, 90%, etc.), the mobile device processor may set a tampered flag or bit in a secure area of the mobile device.

Select systems and/or subsystems (e.g., modem processor subsystem, etc.) in the mobile device may monitor the tampered flag/bit in the secure area of the mobile device, and automatically perform responsive actuation operations (e.g., operations to revert the device to a previous version of software/firmware, restore a subsidy lock on the device, disable the mobile device, etc.) in response to determining that the tampered flag/bit has been set.

By storing the flashing information in a secure area of the mobile device, various embodiments ensure that the mobile device processor maintains a record of the flashing operations performed on the mobile device even when the mobile device's non-volatile memories are erased and reprogrammed by a flashing operation. In addition, by configuring specific systems and subsystems in the mobile device to always check for tampered flag/bit and automatically perform responsive operations when the tampered flag/bit is set, various embodiments may ensure any flashing operations that erase and reprogram the mobile device (including its high-level operating system) do not prevent the mobile device from detecting and responding to unauthorized flashing operations.

In some embodiments, the mobile device may be configured to work in conjunction with a server computing device and an authorized flashing tool/source to determine whether flashing operations detected on the mobile device are authorized by a trusted entity (e.g., OEM, lender, network service provider, etc.) before the detected flashing operations are loaded or executed by the mobile device. In such embodiments, the mobile device may be configured to monitor various systems and subsystems in the mobile device to detect a flashing command from a flashing tool or source. In response to detecting a flashing command, the mobile device may send a notification message to the server computing device, generate and store a flashing request value in a secure area of the mobile device, and send the flashing request value to the flashing tool/source. Flashing tools or sources authorized to erase and/or reprogrammed the mobile device may be configured to receive and forward the flashing request value to the server computing device.

The server computing device may be configured to receive the notification message from the mobile device and the flashing request value from the authorized flashing tool/source. The server computing device may generate a secured flashing request value by signing, hashing and/or encrypting the received flashing request value with a private key, add the secured flashing request value to a notification-response message, and send the notification-response message to the mobile device.

The mobile device may receive the notification-response message that includes the secured flashing request value from the server computing device, use a public key to unencode or decrypt the secured flashing request value, and determine whether the unencoded/decrypted values match the flashing request value stored in the secure area of the mobile device. If the unencoded/decrypted values match the stored flashing request value, the mobile device may perform the detected flashing operations on the mobile device. On the other hand, if the unencoded/decrypted values do not match the stored flashing request value, the mobile device may perform various operations to prevent the loading or execution of the detected flashing operations on the mobile device.

These operations help ensure that flashing operations performed on the mobile device are authorized by a trusted entity (e.g., OEM, lender, network service provider, etc.), and prevent criminals and nefarious actors from using flashing tools or over-the-air updates to erase and reprogram a mobile device with an unauthorized or non-benign software image.

For all the above reasons, the various embodiments improve the performance, security and functioning of the mobile device. Additional improvements to the performance, security and functioning of the mobile device will be evident from the disclosures below.

The term “mobile device” is used herein to refer to any one or all of cellular telephones, smartphones, Internet-of-things (IOT) devices, personal or mobile multi-media players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes communication circuitry for accessing cellular or wireless communication networks.

Subsidy locks may be added or removed from a mobile device via a “flashing” process. A subsidy lock is a technical restriction built into a mobile device (e.g., a smartphone) by an original equipment manufacturer (OEM) or original design manufacturer (ODM) that allows a network service provider to restrict the use of the mobile device to specific countries and/or networks. Network providers often offer subsidy-locked mobile devices at a discount to customers in exchange for a contract to pay for the use of their network for a specified time period, usually between one and three years. The subsidy lock prohibits users from changing network providers for the contract period, which allows the lender or network provider to recoup the costs of the mobile device over the life of the network service contract.

Flashing is a process in which the non-volatile storage of a mobile device is programmed/reprogrammed to add or update the operating system and device specific software stored in non-volatile memory (e.g., FLASH memory) on the mobile device. During flashing, the mobile device is tethered (e.g., via a Universal Serial Bus (USB) cable, UART, PCIe interface, etc.) to an external computing system that includes the software image to be installed on the mobile device. The external computing system causes the mobile device to erase its non-volatile storage (including any previously installed subsidy locks) and load software images that install a new operation system and/or device specific software on the mobile device. If the new software image does not include, implement or enforce a subsidy lock, the mobile device becomes “unlocked” and may be used with any service provider network.

To prevent the unauthorized removal of subsidy locks, access to flashing or re-flashing equipment has traditionally been restricted or controlled by ODM/OEM, lender, or network service provider. However, in recent years, flashing tools (e.g., Ultimate Multi tool, QC Fire tool, etc.), OEM over-the-air software updates, and similar technologies that erase and/or reprogram the non-volatile memories of mobile devices have become widely available on the Internet and thus more accessible to the general public. Criminals and nefarious actors may use these technologies to gain unauthorized control or access over a mobile device. For example, a criminal may purchase a subsidy locked mobile device at a significant discount, use a flashing tool to erase its non-volatile memories, and install on mobile device an unauthorized and/or unauthenticated software image that removes or overwrites the subsidy locks on the mobile device without authorization or approval from the lender, device manufacturer or network service provider. A criminal could then cease making payments to the lender and/or sell the unlocked device at a significant markup in price.

Some device manufacturers equip their mobile devices with conventional “secure boot” features that could be used to prevent criminals and nefarious actors from using flashing tools, OEM over-the-air software updates, or other similar technologies to install unauthorized or unauthenticated software images on the mobile device.

Secure boot is a conventional security solution in which each software image in a boot sequence is authenticated by a different previously verified software image. As such, secure boot builds a chain of trust, starting with a first piece of immutable software that operates from non-volatile storage or read-only-memory (ROM). The first piece of immutable software, which in certain software architectures is referred to as the first ROM bootloader or a primary bootloader (PBL), verifies the signature of the next bootloader in the chain, which is sometimes called a secondary bootloader (SBL) or an extensible bootloader (XBL). The SBL or XBL then cryptographically verifies the signature of the next software image, which may be a feature-rich application bootloader that is specific to the operating system that will subsequently be loaded on the mobile device. These operations may be repeated until all the of software images in the boot sequence, and the operating system, are evaluated, installed, discarded, loaded or executed on the mobile device.

In addition, each software image in the boot sequence may be an Executable and Linkable Format (ELF) software image that includes a certificate chain. An “attestation certificate” may be lowest level certificate authorizing the signature of the ELF software image, and may be signed by the “attestation CA certificate,” which may in turn be signed by the “root CA certificate.” The root CA certificate may be validated by comparing a hash of the root CA certificate to values stored in eFuses, which are hardware embedded one-time programmable bits that once “blown” cannot be readily reverted to an “unblown” state. Generally, the root CA hash value may only be written in the eFuses by the OEM/ODM. This provides the OEM/ODM significant control over the mobile device's cryptographic root of trust, and helps ensure that unauthorized or unauthenticated software images are not installed on the mobile device.

While conventional secure boot features (e.g., certificates, chain of trust, etc.) could be effective at deterring novice criminals from unlocking subsidy locked devices, more sophisticated criminals and hackers have found ways to circumvent such conventional security solutions.

For example, in mobile devices that implement conventional secure boot solutions, when the primary bootloader (PBL) fails to verify the secondary bootloader (SBL), the mobile device enters a special mode of operation called emergency download mode (EDL). The emergency download mode is a USB interface mode in which the mobile device polls its USB interface to determine whether there is a digitally-signed programmer software image available for downloading to the mobile device. If so, the mobile device downloads and uses the digitally-signed programmer software image, in lieu of the SBL, to verify the signature of the next software image in the chain of trust. This allows the mobile device to be updated by a trusted entity (e.g., OEM, lender, etc.) after the initial flashing operations, for the mobile device to restored to an operating condition if the SBL cannot be verified (e.g., due to an attempt hack or cyber-attack, etc.), and for the device to eventually be unlocked after the contract period expires.

While there are important benefits to allowing the mobile device to operate in the emergency download mode and assume/trust that a programmer software image that is digitally signed by a trusted entity (e.g., the OEM, etc.) is approved and authorized for executing on the mobile device, criminals and hackers could exploit these features to circumvent conventional security systems of the mobile device.

For example, due to hacks and leaks in recent years, criminals and nefarious actors now have access to a variety of different OEM-digitally-signed programmer software images. A criminal could modify an OEM-digitally-signed programmer software image to load or authenticate a non-benign or unauthorized software image that unlocks the mobile device. The criminal could add this modified programmer software image to the mobile device's USB interface, and cause the mobile device to enter emergency download mode (EDL). In response, the mobile device may download and use the modified programmer software image to authenticate the non-benign or unauthorized software image, which could further authenticate other non-benign or unauthorized software images. These software images could erase and reprogram the mobile device so that it no longer includes a subsidy lock.

In addition to the examples above, sophisticated criminals and hackers have found other ways to circumvent the security features in mobile devices and remove their subsidy locks. As such, nothing in this application or the claims should be limited to the examples above.

The various embodiments include methods, and mobile devices configured to implement the methods, that limit or prevent the circumvention of existing security features of the mobile device (e.g., secure boot, etc.), and prevent criminals and nefarious actors from successfully installing, loading or executing an unauthorized or unauthenticated software images on the mobile device (e.g., to remove its subsidy lock, etc.).

In some embodiments, a mobile device may be equipped with security enabled software and/or hardware (e.g., eFuses, QFPROMs, RPMB, security enabled hardware, etc.) that establish, create or form secure areas within the mobile device. One or more of the secure areas may include a tampered flag or bit, and the mobile device may include various systems and subsystems (e.g., modem processor subsystem, etc.) that are configured to perform specific operations (e.g., to limit access to critical resources, disable a subsystem, etc.) in response to detecting that the tampered flag or bit has been set. In addition, the mobile device may include an action-command information structure (e.g., table, map, database, etc.) that stores values hashed with an International Mobile Equipment Identity (IMEI) number or a hardware key (HW key) in an instruction memory (IMEM) or secure area of the mobile device.

The mobile device may be configured to store flash control information in a secure area during the first successful boot up of the mobile device, when secure boot is enabled, and/or during the provisioning of the secure areas.

During operation or use of the mobile device, the mobile device may monitor its various systems and subsystems for flashing operations that include an erase or program command In response to detecting an erase or program command, the mobile device (or flash programmer, PBL, etc.) may further monitor the systems/subsystems to collect flashing information, such as flashing source information (e.g., flashing commands were issued from software flash using USB Sahara protocol, etc.), the commands issued by the flashing source (e.g., erase, program, etc.), actions performed by the mobile device or the results of an issued command (e.g., erase flash attempted but failed, etc.), a flashing attempt counter that identifies the number of times that flashing operations have been detected on the mobile device, timestamps, and/or other similar information.

The mobile device may verify the integrity of the collected information to ensure that the data is authentic, has not been tampered with, etc., and store the verified information in a secure area of the mobile device.

The mobile device may be configured so that, on each reboot, the mobile device evaluates and compares the verified information stored in the secure areas with the information stored in the action-command information structure to determine whether flashing operations completed most recently were benign, suspicious, or non-benign. For example, the mobile device may compare the flashing attempt counter to information stored in the action-command information structure to determine whether the number of flashing attempts within a time period exceeds a threshold of acceptable hashing attempts for that time period. As further examples, the mobile device may check the authenticity of new flash content in response to determining that a flash erase has been attempted, determine whether any critical areas of the mobile device were erased or overwritten with incorrect or inconsistent information, determine whether an IMEI, subscriber identity module (SIM) lock (or any other type of subsidy lock), or other security critical information was erased, etc. Based on the results of these operations, the mobile device may adjust the probability value that indicates the likelihood that the recent flashing operations installed an unauthorized or unauthenticated software image on the mobile device.

The mobile device may determine whether the probability value exceeds a threshold value, classify the recent flashing operations are non-benign in response to determining that the probability value exceeds the threshold value, and set the tampered flag or bit in the secure area of the mobile device in response to determining that the most recent flashing operations are non-benign.

The modem processor and other systems/subsystems in the mobile device may detect that the tampered flag or bit has been set, and perform various operations to prevent the installation or execution of the corresponding software image, to recover or reflash the mobile device, to revert the device to its previous version of software/firmware, or to disable a subset of the functions of mobile device until the mobile device is re-flashed by the OEM, lender, network service provider or an authorized third-party.

In some embodiments, the mobile device may be configured to monitor various systems and subsystems in the mobile device to detect flashing operations that include an erase or program command In response to detecting flashing operations that include an erase or program command, and prior to performing the detected flashing operations, the mobile device may generate and send a notification message to a server of a trusted entity (e.g., OEM, lender, network service provider, etc.). The notification message may indicate that flashing operations have been detected on the mobile device, and include flashing information (e.g., flashing source information, flashing attempt counter, etc.), information identifying the current operating state of the mobile device, and other conditions or events detected on the mobile device.

In response to sending the notification message, the mobile device may generate a random or pseudo-random number, generate a flashing request value by appending a special code/string to the random or pseudo-random number, and store the generated flashing request value in a secure area of the mobile device. The mobile device may also send the generated flashing request value to the source of the detected flashing operations (e.g., a flashing tool, an over-the-air (OTA) update server, etc.). If the source of flashing operations is an authorized flashing source, it would be configured to forward the flashing request value to the trusted entity server (or same system, cluster, etc.) that received the notification message from the mobile device.

The trusted entity server may receive the notification message from the mobile device, receive the flashing request value from an authorized flashing source, generate a secured flashing request value by signing, hashing and/or encrypting the received flashing request value with a private key, add the secured flashing request value to a notification-response message, and send the notification-response message to the mobile device.

The mobile device may receive the notification-response message, use a public key to unencode or decrypt the secured flashing request value, determine whether the unencoded/decrypted values match the flashing request value stored in the secured area of the mobile device, and perform various operations to prevent the loading or execution of the detected flashing operations on the mobile device in response to determining that the unencoded/decrypted values do not match the flashing request value stored in the secured area.

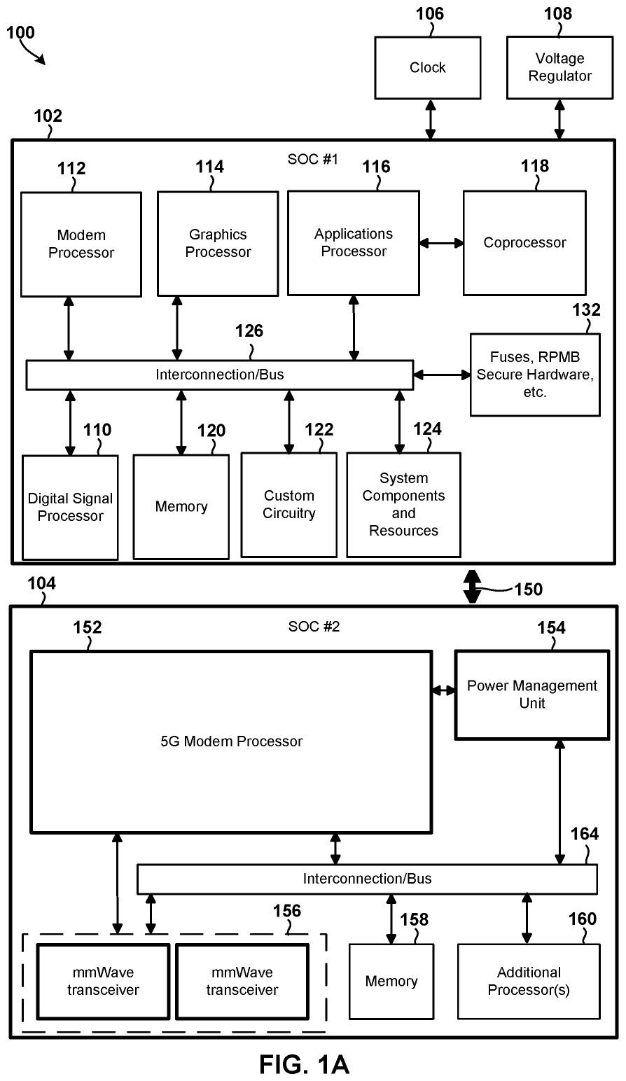

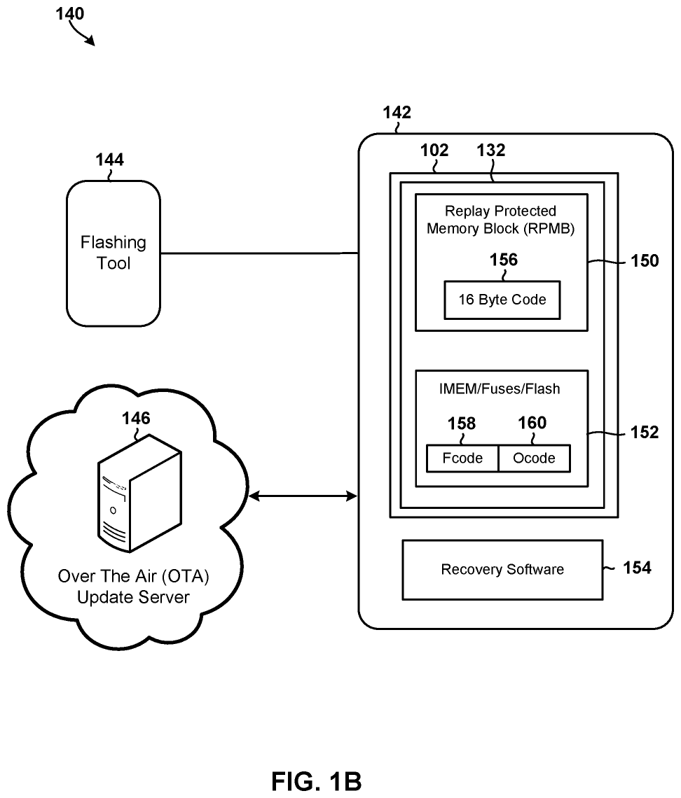

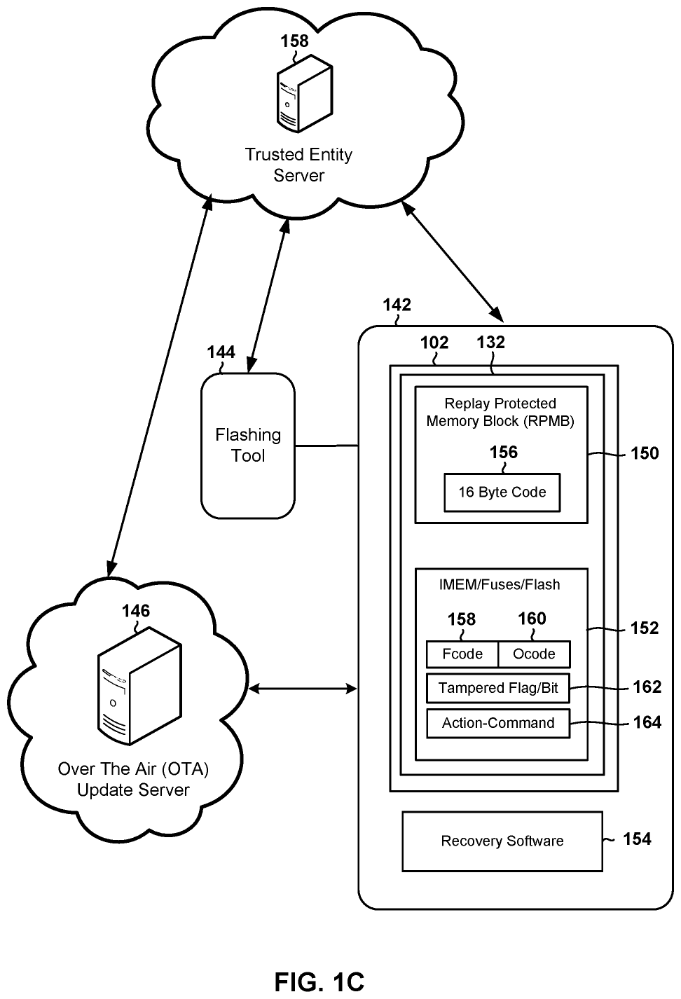

Various embodiments may be implemented on a number of single processor and multiprocessor computer systems, including a system-on-chip (SOC) or system in a package (SIP). FIG. 1A illustrates an example computing system or SIP 100 architecture that may be used in mobile devices implementing the various embodiments.

In the example illustrated in FIG. 1A, the SIP 100 includes a two SOCs 102, 104, a clock 106, and a voltage regulator 108. In some embodiments, the first SOC 102 operate as central processing unit (CPU) of the mobile device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high frequency short wave length (e.g., 28 GHz mmWave spectrum, etc.) communications.

In the example illustrated in FIG. 1A, the first SOC 102 includes a digital signal processor (DSP) 110, a modem processor 112, a graphics processor 114, an application processor 116, one or more coprocessors 118 (e.g., vector co-processor) connected to one or more of the processors, memory 120, custom circuity 122, system components and resources 124, an interconnection/bus module 126, and fuses, replay protected memory block (RPMB) and secure hardware module 132. The fuses, RPMB, and secure hardware module 132 may include eFuses, QFPROMs, secure bits, secure flags, security enabled hardware, secure memory, or hardware, software, or firmware used to implement a secure portion of the operating system, a secure operating system (SOS), a trusted execution environment (TEE), etc.

The second SOC 104 includes a 5G modem processor 152, a power management unit 154, an interconnection/bus module 164, a plurality of mmWave transceivers 156, memory 158, and various additional processors 160, such as an applications processor, packet processor, etc.

Each processor 110, 112, 114, 116, 118, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 10). In addition, any or all of the processors 110, 112, 114, 116, 118, 152, 160 may be included as part of a processor cluster architecture (e.g., a synchronous processor cluster architecture, an asynchronous or heterogeneous processor cluster architecture, etc.).

The first and second SOC 102, 104 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, access ports, timers, and other similar components used to support the processors and software clients running on a mobile device. The system components and resources 124 and/or custom circuitry 122 may also include circuitry to interface with peripheral devices, such as cameras, electronic displays, external memory chips, etc.

The first and second SOC 102, 104 may communicate via interconnection/bus module 150. The various processors 110, 112, 114, 116, 118, may be interconnected to one or more memory elements 120, system components and resources 124, and custom circuitry 122, and the fuses/RPMB/secure hardware module 132 via an interconnection/bus module 126. Similarly, the processors 152, 160 may be interconnected to the power management unit 154, the mmWave transceivers 156, memory 158, and various additional processors 160 via the interconnection/bus module 164. The interconnection/bus module 126, 150, 164 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 102, 104 may further include an input/output module (not illustrated) for communicating with resources external to the SOC, such as a clock 106 and a voltage regulator 108. Resources external to the SOC (e.g., clock 106, voltage regulator 108) may be shared by two or more of the internal SOC processors/cores.

In addition to the SIP 100 discussed above, the various embodiments may be implemented in a wide variety of computing systems, which may include a single processor, multiple processors, multicore processors, or any combination thereof.

FIGS. 1B and 1C illustrate a system 140 suitable for implementing some embodiments. In the example illustrated in FIG. 1B, the system 140 includes a mobile device 142 coupled to a flashing tool 144 and/or configured to receive over the air (OTA) software updates from an OTA update server 146. The mobile device 142 may include recovery software 154 and an SOC 102 that includes a fuses/RPMB/secure hardware module 132. The fuses/RPMB/secure hardware module 132 may include a replay protected memory block (RPMB) module 150, an IMEM/Fuses/Flash module 152, and/or other security enabled hardware (e.g., eFuses, QFPROMs, RPMB, security enabled hardware, etc.) or software that establish, create or form secure areas within the mobile device 142. The RPMB module 150 may include a 16-byte code value 156. The IMEM/Fuses/Flash module 152 may include an Fcode 158, an Ocode 160, a tampered flag (Tflag) 162, and/or an action-command 164 information structure.

The mobile device 142 may be configured to store flash control information as a 16-byte code value 156 in the in the RPMB module 150 during the first successful boot up of the mobile device, when secure boot is enabled, and/or during the provisioning of the secure areas. During operation or use of the mobile device, the mobile device may monitor its various systems and subsystems for an erase and/or a program flashing command from the flashing tool 144 and/or a binary software image from the OTA update server 146.

In response to detecting the erase/program command from the flashing tool 144, the mobile device 142 may generate a random or pseudo-random number, generate a flashing request value by appending the random or pseudo-random number to a hash of an IMEI number or hardware key, and store the generated flashing request value as the Fcode 158 in the IMEM/Fuses/Flash module 152. Similarly, in response to detecting the binary software image from the OTA update server 146, the mobile device 142 may generate a flashing request value by appending a special code/string (e.g., a hash of an IMEI number or hardware key, etc.) to a random or pseudo-random number, and store the generated flashing request value as the Ocode 158 in the IMEM/Fuses/Flash module 152. Alternatively or in addition, the mobile device 142 may monitor its systems/subsystems to collect flashing information (e.g., flash attempts, etc.), verify the integrity of the collected information to ensure that the data is authentic and not tampered with, and store the verified information in a secure area (e.g., RPMB module 150, etc.) of the mobile device.

On each reboot, the mobile device 142 may compare the 16-byte code value 156 in the RPMB module 150 with the Fcode 158 or Ocode 158 in the IMEM/Fuses/Flash module 152 to determine whether they match. If the 16-byte code value 156 in the RPMB module 150 does not match the Fcode 158 or Ocode 158 in the IMEM/Fuses/Flash module 152, the mobile device 142 may set tampered flag/bit 162 to one (or zero) to indicate that the most recent flashing operations are non-benign.

The modem processor 112 or other systems/subsystems in the mobile device 142 may detect that the tampered flag/bit 162 has been set, and perform various operations to prevent the installation or execution of the corresponding software image, to recover or reflash the mobile device, to revert the device to its previous version of software/firmware, or to disable a subset of the functions of mobile device until the mobile device is re-flashed by the OEM, lender, network service provider or an authorized third-party.

In the example illustrated in FIG. 1C, the system 140 further includes a trusted entity server 158 that is communicatively coupled to the flashing tool 154, OTA update server 146, and mobile device 140, such as via a 5G network or the Internet. In response to detecting an erase/program command from the flashing tool 144 and/or a binary software image from the OTA update server 146, and prior to performing the detected flashing operations (e.g., installing the software image or executing the erase/program commands, etc.), the mobile device 142 may generate and send a notification message to the trusted entity server 158. The notification message may indicate that flashing operations have been detected on the mobile device, and include flashing information (e.g., flashing source information, flashing attempt counter, etc.), information identifying the current operating state of the mobile device, and other conditions or events detected on the mobile device.

In response to sending the notification message, the mobile device 142 may generate a random or pseudo-random number, generate a flashing request value by appending a special code/string to the random or pseudo-random number, and store the generated flashing request value in a secure area of the mobile device. The mobile device 142 may also send the generated flashing request value to the source of the detected flashing operations (e.g., flashing tool 144 or OTA update server 146). If the source of flashing operations is an authorized flashing source, it would be configured to forward the flashing request value to the trusted entity server 158.

The trusted entity server 158 may receive the notification message from the mobile device 142, receive the flashing request value from an authorized flashing source, generate a secured flashing request value by signing, hashing and/or encrypting the received flashing request value with a private key, add the secured flashing request value to a notification-response message, and send the notification-response message to the mobile device 142.

The mobile device 142 may receive the notification-response message, use a public key to unencode or decrypt the secured flashing request value, determine whether the unencoded/decrypted values match the flashing request value stored in the secured area of the mobile device, and perform various operations to prevent the loading or execution of the detected flashing operations on the mobile device in response to determining that the unencoded/decrypted values do not match the flashing request value stored in the secured area.

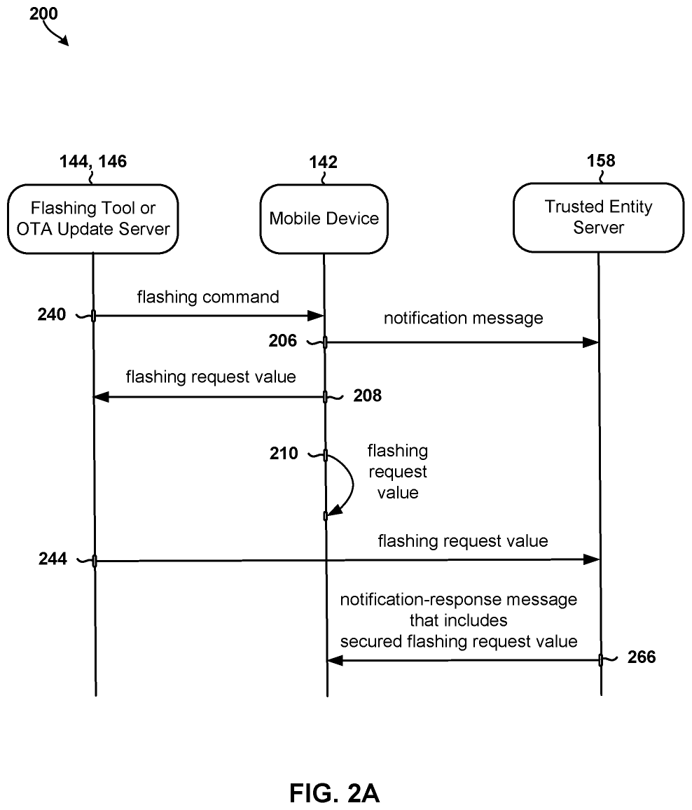

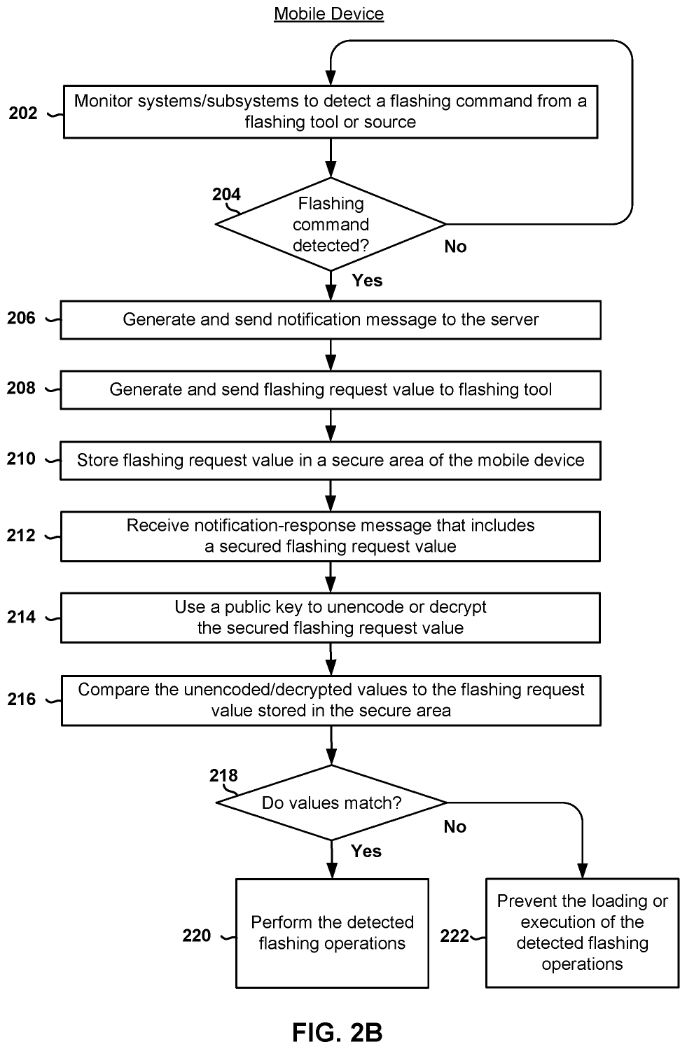

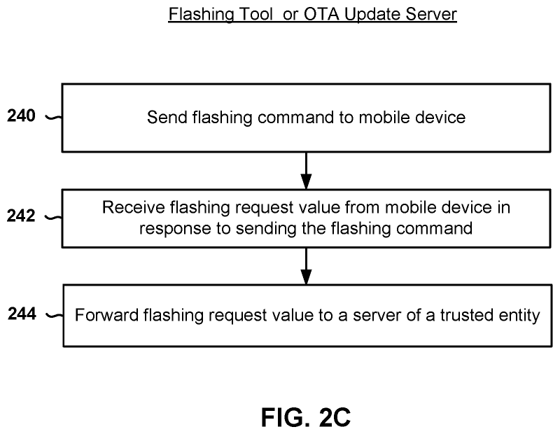

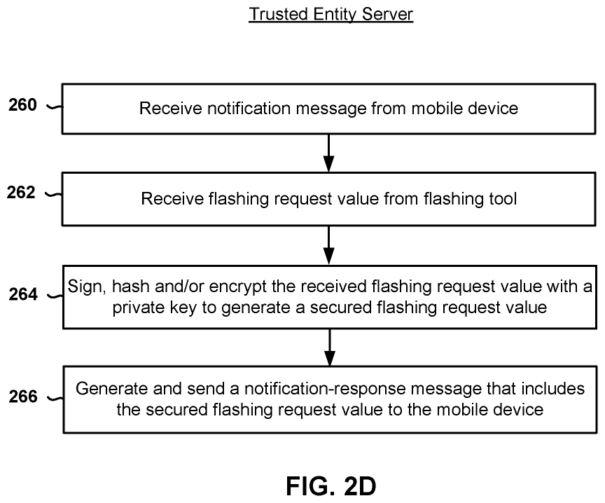

FIGS. 2A-2D illustrate a method 200 for preventing criminals and nefarious actors from circumventing existing security features (e.g., secure boot, etc.) of the mobile device to install, load or execute unauthorized flashing command or unauthorized software images on the mobile device (e.g., to remove its subsidy lock, etc.). All or portions of the method 200 may be performed by one or more processors in one or more computing devices, such as a flashing tool 144, an OTA update server 146 computing device, a mobile device 142, and a trusted entity server 158 computing device.

With reference to FIGS. 2A and 2B, in block 202, a processor in a mobile device may monitor its systems/subsystems for execution of a flashing command from a flashing tool or source (e.g., flashing tool 144 or OTA update server 146). In some aspects, monitor its systems/subsystems for execution of a flashing command may include monitoring for flashing operations initiated by a flashing tool. In some aspects, monitor its systems/subsystems for execution of a flashing command may include monitoring subsystems that will respond to reprogramming operations initiated by a bootloader. Other mechanisms for monitoring for a flashing command may be used in various embodiments.

In determination block 204, the mobile device processor may determine, based on the monitoring, whether a flashing command was detected in the mobile device. For example, the monitoring operations may detect that a flashing tool has issued a command or initiated an operation consistent with flashing operations. As another example, the monitoring operations in block 202 may detect that a bootloader has issued a command or initiated an operation consistent with reprogramming operations.

In response to determining that flashing command was not detected (i.e., determination block 204=“No”), the mobile device processor may continue monitoring its systems/subsystems to detect a flashing command in block 202.

In response to determining that flashing command was detected (i.e., determination block 204=“Yes”), the mobile device processor may generate and send a notification message to a trusted entity server in block 206. Such a notification message may include flashing information (e.g., flashing source information, flashing attempt counter, etc.), information identifying the current operating state of the mobile device, and other conditions or events detected on the mobile device. The notification message may be configured to enable the trusted entity server to anticipate receiving a flashing request value from a flashing tool/source and to execute operations to authenticate the flashing tool/source as described herein.

In block 208, the mobile device processor may generate and send a flashing request value to a flashing tool/source. In some embodiments, processor may generate the flashing request value by generating a random or pseudo-random number and appending the number to a hash of an IMEI number or hardware key, or other similar value.

In block 210, the mobile device processor may store the generating flashing request value in a secure area of the mobile device in block 210. By storing the flashing information in a secure area of the mobile device, various embodiments ensure that the mobile device processor maintains a record of the flashing operations performed on the mobile device even when the mobile device's non-volatile memories are erased and reprogrammed by a flashing operation.

It should be understood that any or all of the operations in blocks 206-210 may be performed concurrently and/or in any order. For example, in some embodiments, the mobile device processor may generate and store the flashing request value in block 210 and send the notification message to a trusted entity server in block 206 before sending the flashing request value to a flashing tool/source in block 208.

In block 212, the mobile device may receive a notification-response message that includes a secured flashing request value from the trusted entity server. The secured flashing request value may be received in encrypted form and/or the notification-response message may be sent via a secure communication link between the mobile device and the server. In various embodiments, the mobile device may receive the notification-response message via any of a variety of communication methods, including such as simple message service (SMS), email, a notification message via an overhead channel of a wireless communication link, a notification to query the server for a message, etc.

In block 214, the mobile device processor may use a public key to unencode or decrypt the secured flashing request value included in the notification-response message received from the trusted entity server. Any known method of decrypting data packets may be used in block 214.

In block 216, the mobile device processor may compare the unencoded/decrypted values to the flashing request value stored in the secure area. For example, this comparison may be a simple subtraction and check for a remainder.

In determination block 218, the mobile device processor may determine, based on the comparison results in block 216, whether the unencoded/decrypted values match (or are the same as) the flashing request value stored in the secure area of the mobile device. In some embodiments the operations in block 216 and in determination block 218 may be accomplished in one operation.

In response to determining that the unencoded/decrypted values match the flashing request value stored in the secure area of the mobile device (i.e., determination block 218=“Yes”), the mobile device processor may perform the detected flashing operations in block 220. In other words, normal flashing operations may be permitted to execute in block 220. In some embodiments, the processor may also determine that the detected flashing operations are authorized as part of the operations in block 220.

In response to determining that the unencoded/decrypted values do not match the flashing request value stored in the secure area of the mobile device (i.e., determination block 218=“No”), the mobile device processor may discard the detected flashing operations or otherwise prevent the loading or execution of the detected flashing operations on the mobile device in block 222. In some embodiments, the processor may also determine that the detected flashing operations are not authorized as part of the operations in block 222.

Operations within a flashing tool or an over-the-air update server are illustrated in FIG. 2C. With reference to FIGS. 2A and 2C, in block 240, a processor in a flashing source (e.g., a flashing tool 144, an OTA update server 146, etc.) may send a flashing command to the mobile device. The flashing command may be an erase command, a program command, a software update command, a software image, etc. Such flashing commands may be any standard commands associated with erasing, storing data to or updating stored instructions within a flash memory.

In block 242, the flashing source may receive a flashing request value from the mobile device in response to sending the flashing command to the mobile device. As discussed above, the flashing request value may include a random or pseudo-random number that is appended to a hash of an IMEI number or hardware key, or other similar value.

In block 244, the flashing source may forward the flashing request value to a server computing device of a trusted entity (e.g., trusted entity server 158, or server operated by the OEM, lender, network service provider, etc.). If the flashing source is a flash tool connected to the mobile device, the flashing source may use communication links established by the mobile device. If the flashing source is independent of the mobile device, such as an over-the-air update server, the flashing source may send the flashing request value via a network connection, such as the Internet, in encrypted or unencrypted form.

Operations within the trusted entity server are illustrated in FIG. 2D. With reference to FIGS. 2A and 2D, in block 260, a processor of a server computing device (e.g., trusted entity server 158, etc.) may receive the notification message from the mobile device that was sent in block 206. The notification message may indicate that flashing operations have been detected on the mobile device, and include flashing information (e.g., flashing source information, flashing attempt counter, etc.), information identifying the current operating state of the mobile device, and other conditions or events detected on the mobile device.

In block 262, the server computing device may receive the flashing request value from a flashing source that was sent in block244.

In block 264, the server computing device may sign, hash and/or encrypt the received flashing request value with a private key to generate a secured flashing request value. Any of a variety of conventional mechanisms for signing values, generating hash values and encrypting values may be used by the server in block 264.

In block 266, the server computing device may generate and send a notification-response message that includes the secured flashing request value to the mobile device. In some embodiments the server computing device may establish a secure communication link with the mobile device and then send the notification-response message via the secure communication link between the mobile device and the server. In some embodiments, the server computing device may send the notification-response message via any of a variety of communication methods, including such as simple message service (SMS), email, a notification message via an overhead channel of a wireless communication link, a notification that the mobile device should query the server for a message, etc.

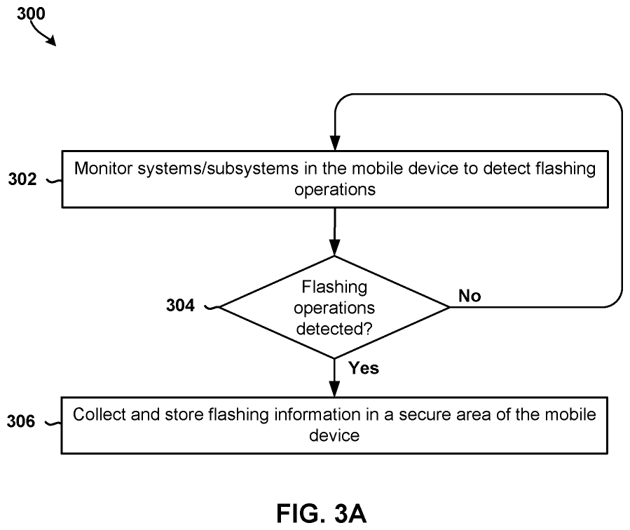

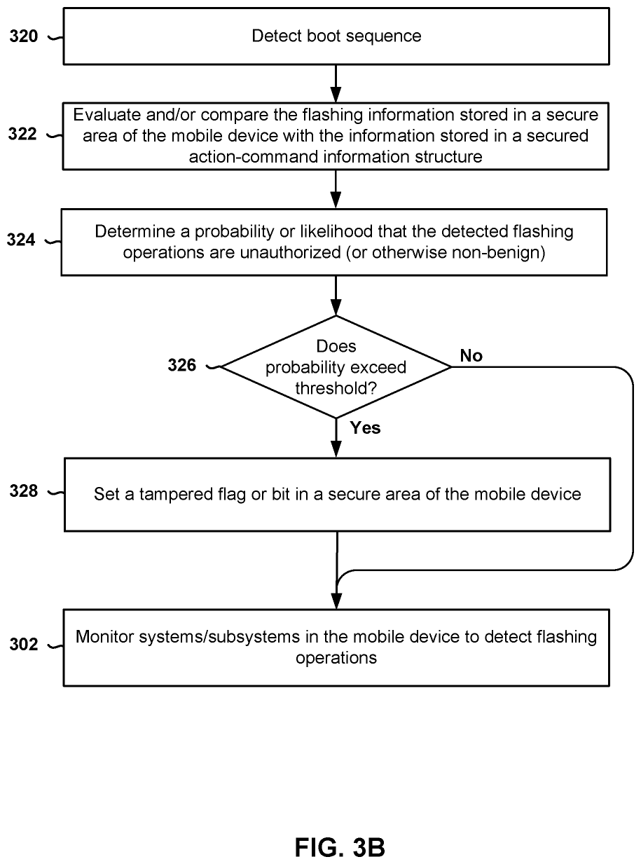

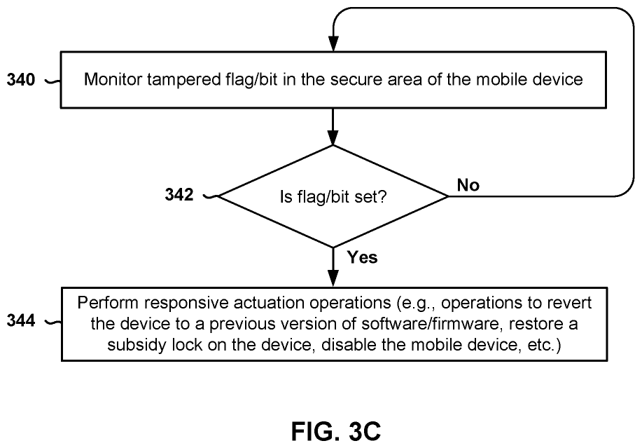

FIG. 3A-3C illustrate another method 300 for detecting and responding to unauthorized flashing command or unauthorized software images on the mobile device (e.g., to remove its subsidy lock, etc.). All or portions of method 300 may be performed by a processor in a computing device, such as the mobile device 142 illustrated in FIG. 1B.

With reference to FIG. 3A, a processor in a mobile device may monitor various systems/subsystems in the mobile device to detect flashing operations. In some aspects, monitor its systems/subsystems for execution of a flashing command may include monitoring for flashing operations initiated by a flashing tool. In some aspects, monitor its systems/subsystems for execution of a flashing command may include monitoring subsystems that will respond to reprogramming operations initiated by a bootloader. Other mechanisms for monitoring for a flashing command may be used in various embodiments.

In determination block 304, the mobile device processor may determine whether there were any flashing operations/commands detected in the mobile device. For example, the monitoring operations may detect that a flashing tool has issued a command or initiated an operation consistent with flashing operations. As another example, the monitoring operations in block 202 may detect that a bootloader has issued a command or initiated an operation consistent with reprogramming operations.

In response to determining that there were no flashing operations/commands detected in the mobile device (i.e., determination block 304=“No”), the mobile device processor may continue monitoring its systems/subsystems to detect a flashing operations/commands in block 302.

In response to determining that flashing operations/commands were detected (i.e., determination block 304=“Yes”), the mobile device processor may collect and store flashing information in a secure area of the mobile device in block 306. As noted above, such flashing information may include flashing source information identifying a flashing source (i.e., an identity of the flashing tool or over-the-air update server initiating the flashing operation), information identifying a command issued by the flashing source, information identifying an action performed by the mobile device in response to the command issued by the flashing source, a result generated in the mobile device from performance of the command issued by the flashing source, flashing attempt counter recording the number of times that flashing operations have been detected on the mobile device over a period of time, etc. By storing the flashing information in a secure area of the mobile device, various embodiments ensure that the mobile device processor maintains a record of the flashing operations performed on the mobile device even when the mobile device's non-volatile memories are erased and reprogrammed by a flashing operation. In some embodiments, storing the collected flashing information in the secure area of the mobile device may include incrementing the flashing attempt counter in the secure area of the mobile device that identifies the number of times that flashing operations have been detected on the mobile device.

In some embodiments, collecting flashing information in block 306 may include one or more of: collecting flashing information in response to detecting an erase command in a boot sequence; collecting flashing information in response to detecting a program command in the boot sequence; collecting flashing information in response to detecting a software update image from an over-the-air update server; or collecting flashing information in response to determining that a primary bootloader (PBL) of a secure boot feature of the mobile device failed to verify a secondary bootloader (SBL) and the mobile device has commenced entering emergency download mode (EDL).

In various embodiments, storing the collected flashing information in the secure area of the mobile device may be performed during a first bootup of the mobile device, when secure boot is enabled or during the provisioning of secure areas of the mobile device.

With reference to FIG. 3B, in block 320, the mobile device processor may detect that a boot sequence has been initiated in the mobile device. In some embodiments, rather than the processor detecting a boot sequence, the boot sequence may include the operations illustrated in FIG. 3B.

In block 322, the mobile device processor may evaluate and/or compare the flashing information stored in a secure area of the mobile device with the information stored in a secured action-command information structure to generate an evaluation result. For example, the evaluation result may be an indication (e.g., a bit) of whether the flashing information stored in a secure area of the mobile device matches—or does not match—the information stored in a secured action-command information structure. As another example, the evaluation result may be value indicative of the extent to which the flashing information stored in a secure area of the mobile device matches or is similar (or dissimilar) to the information stored in a secured action-command information structure. In some embodiments, the secured action-command information structure stores values hashed with an International Mobile Equipment Identity (IMEI) number or a hardware key (HW key) in an instruction memory or another secure area of the mobile device. In such embodiments, evaluating, on each reboot of the mobile device, the flashing information stored in the secure area of the mobile device and information stored in the secured action-command information structure to generate the evaluation result may include comparing the flashing information stored in the secure area of the mobile device with a value hashed with the IMEI number or the HW key in the instruction memory or other secure area of the mobile device. In some embodiments, the evaluation or comparison operations in block 322 may include comparing, on each reboot, the flashing information stored in the secure area with the information stored in the secured action-command information structure to determine whether flashing operations completed most recently were non-benign.

In block 324, the mobile device processor may determine a probability or likelihood that the detected flashing operations are unauthorized (or otherwise non-benign). In some embodiments, the operations in block 324 may be limited to determining an arbitrary value according to an algorithm that determines the arbitrary value based on the evaluation and/or comparison of flashing information performed in block 322. In some embodiments, determining the probability value in block 324 may include determining, based on the evaluation result, whether an IMEI number, subsidy lock or security critical information was erased from the mobile device. In some embodiments, if the processor determines that an IMEI number, subsidy lock or security critical information was erased from the mobile device, the processor may set the probability value greater than the threshold value. In some embodiments, determining the probability value in block 324 may be based on the number of times that flashing operations have been detected on the mobile device, such as within a set period of time.

In determination block 326, the mobile device processor may determine whether the determined probability that the detected flashing operations are unauthorized exceeds a threshold value. In some embodiments, the operations in determination block 326 may be limited to comparing the arbitrary value determined in block 324 to a threshold value with no determination of probability.

In response to determining that the determined probability exceeds the threshold value (i.e., determination block 326=“Yes”), the mobile device processor may set a tampered flag or bit in a secure area of the mobile device in block 328. This tamper flag or bit may be set in a register that will be checked by the mobile device processor during future boot operations.

In response to determining that the determined probability does not exceed the threshold value (i.e., determination block 328=“No”), the mobile device processor may operate in normal mode. As part of normal mode operations, the mobile device processor may monitor systems/subsystems in the mobile device to detect flashing operations in block 302 as described above. Additionally as part of normal mode operations, the mobile device processor may perform any or all of the operations of the method 300 described with reference to FIG. 3A or 3C. For example, in some embodiments, in response to determining that the determined probability does not exceed the threshold value (i.e., determination block 328=“No”), the mobile device processor may monitor the tampered flag/bit in the secure area of the mobile device in block 340 of the method 300 illustrated in FIG. 3C.

In some embodiments in which the evaluation result generated in block 322 is an indication (e.g., a bit) of whether flashing information stored in a secure area of the mobile device matches—or does not match—the information stored in a secured action-command information structure, the determination made indetermination block 326 may involve the processor checking the indication (e.g., a bit) set in block 322. In such embodiments, in response to determining that the indication (e.g., a bit) is set (i.e., determination block 326=“Yes”), the mobile device processor may set a tampered flag or bit in a secure area of the mobile device in block 328. Also in such embodiments, in response to determining that the indication (e.g., a bit) is not set (i.e., determination block 326=“No”), the mobile device processor may monitor tampered flag/bit in the secure area of the mobile device in block 340 illustrated in FIG. 3C. Thus, the operations in block 324 may not be performed in some embodiments, and the operations of determination block 326 and block 328 may involve the processor selectively setting (or not setting) the tampered flag or bit in the secure area of the mobile device based on the evaluation result.

With reference to FIG. 3C, in block 340, the mobile device processor may monitor tampered flag/bit in the secure area of the mobile device. In determination block 342, the mobile device processor may determine whether the tampered flag/bit has been set (e.g., stores a value of True, 1, etc.). In some embodiments, the operations in block 340 and determination block 342 may be performed in a single operation or line of code.

In response to determining that the tampered flag/bit has not been set (i.e., determination block 342=“No”), the mobile device processor may operate in normal mode, including performing detected flashing operations. Additionally as part of normal mode operations, the mobile device processor may continue monitoring the tampered flag/bit in the secure area of the mobile device in block 340 of the method 300 as described.

In response to determining that the tampered flag/bit has been set (i.e., determination block 342=“Yes”), the mobile device processor may perform responsive actuation operations in block 344. In some embodiments, responsive actuation operations performed in block 344 may include operations to revert the device to a previous version of software/firmware. In some embodiments, responsive actuation operations performed in block 344 may include restoring a subsidy lock on the device. In some embodiments, responsive actuation operations performed in block 344 may include disabling the mobile device. Other types of responsive actuation operations may be performed in block 344.

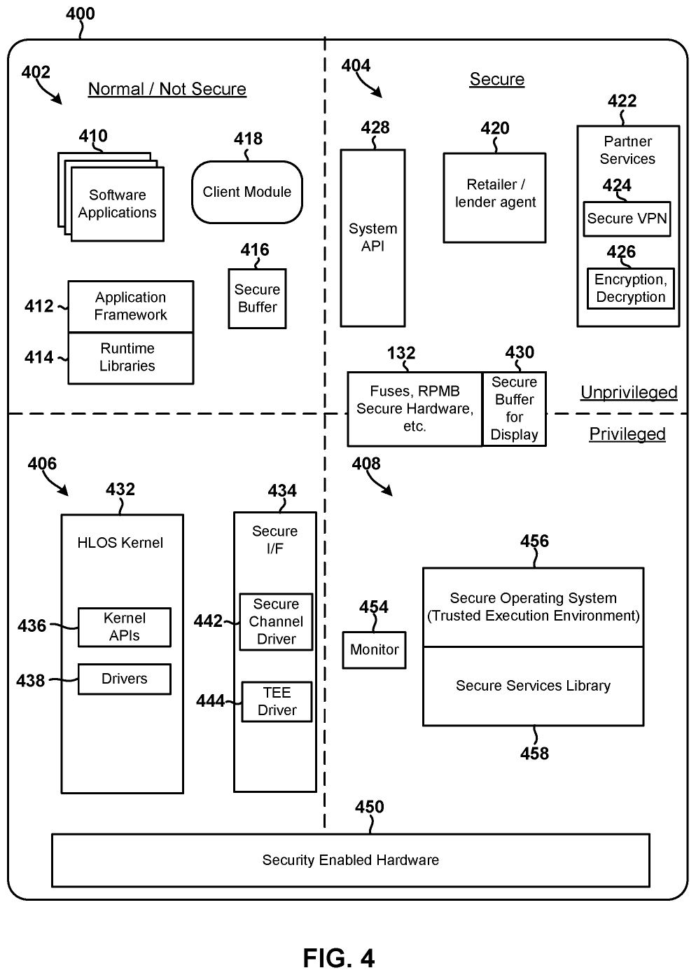

FIG. 4 illustrates example logical and functional components in a mobile device 400 configured in accordance with the embodiments to identify and respond to suspicious and non-benign reprogramming operations, such as flashing operations that erase and reprogram the mobile device to remove the mobile device's subsidy locks without prior authorization or approval from the lender, device manufacturer or network service provider. The mobile device 400 may be configured to implement any of the embodiments discussed in this application, including the embodiments discussed above with reference to FIGS. 1A through 3C.

In the example illustrated in FIG. 4, the mobile device 400 includes a secure computing environment that includes security enabled hardware 450 and software divided into four protection domains/portions, namely an unprivileged-normal portion 402, an unprivileged-secure portion 404, a privileged-normal portion 406, and a privileged-secure portion 408. The unprivileged portions may be within the user space of the operating system kernel, whereas the privileged portions may be within the kernel space of the operating system kernel. Both the user space and the kernel space may each include a secure portion and a non-secure portion.

The unprivileged-normal portion 402 may include software applications 410, an application framework 412, runtime libraries 414, a secure buffer 416, and a client 418 module. The secure buffer 416 may be configured to enable communication between various logical components and across protection domains/portions. In an embodiment, the secure buffer 416 may be configured so that any functional component 410-458 in any protection domain/portion 402-408 may write to its memory, but only functional components 420-428 and 454-458 in the secure portions 404, 408 may read the information stored in the memory. For example, the secure buffer 416 may be configured so that the software applications 410, client 418, and partner services 422 functional components may write to its memory, but only the retailer or lender agent 420 and the partner services 422 functional components may read from its memory.

The unprivileged-secure portion 404 may include a system application programming interface (API) 428, and a partner services 422 functional component that includes a secure virtual private network (VPN) 424 functional component and an encryption/decryption 426 functional component. In an embodiment, the unprivileged-secure portion 404 may also include fuses/RPMB/security hardware module 132 (described above with reference to FIG. 1A) and a secure buffer for display 430. The secure buffer for display 430 may be suitable for communicating security-encrypted information generated in the unprivileged-secure portion 404 to an electronic display or display subsystem of the mobile device 400.

The privileged-normal portion 406 may include core elements of a high level operating system (HLOS) kernel 432 and secure infrastructure (I/F) 434. The HLOS kernel 432 may include a kernel API 436 and drivers 438. The secure infrastructure 434 may include a secure channel driver 442, and a secure operating system or trusted execution environment (TEE) driver 444.

The privileged-secure portion 408 may include a monitor 454, a secure block system (SBS) or trusted execution environment (TEE), and a secure services library 458. In an embodiment, the privileged-secure portion 408 may also include a secure buffer for display 430 and fuses/security hardware 132 (described above with reference to FIG. 1A).

The mobile device 400 may also include a secure communication links (not illustrated separately in FIG. 4) suitable for receiving flashing commands (including software updates, etc.) and communicating with a server computing device of a trusted entity (e.g., trusted entity server 158 illustrated in FIG. 1C, etc.). For example, the secure VPN 324 functional component may receive encrypted information from a network server, the encryption/decryption 326 may decrypt the received information in the unprivileged-secure portion 304 and provide the decrypted information to the client 418 in the unprivileged-normal portion 302.

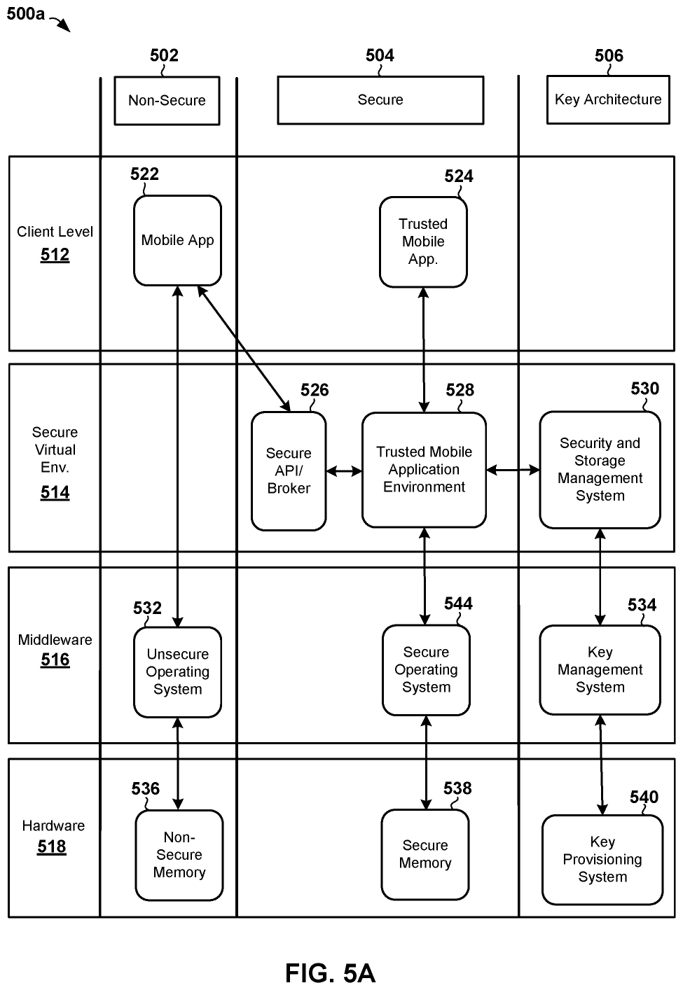

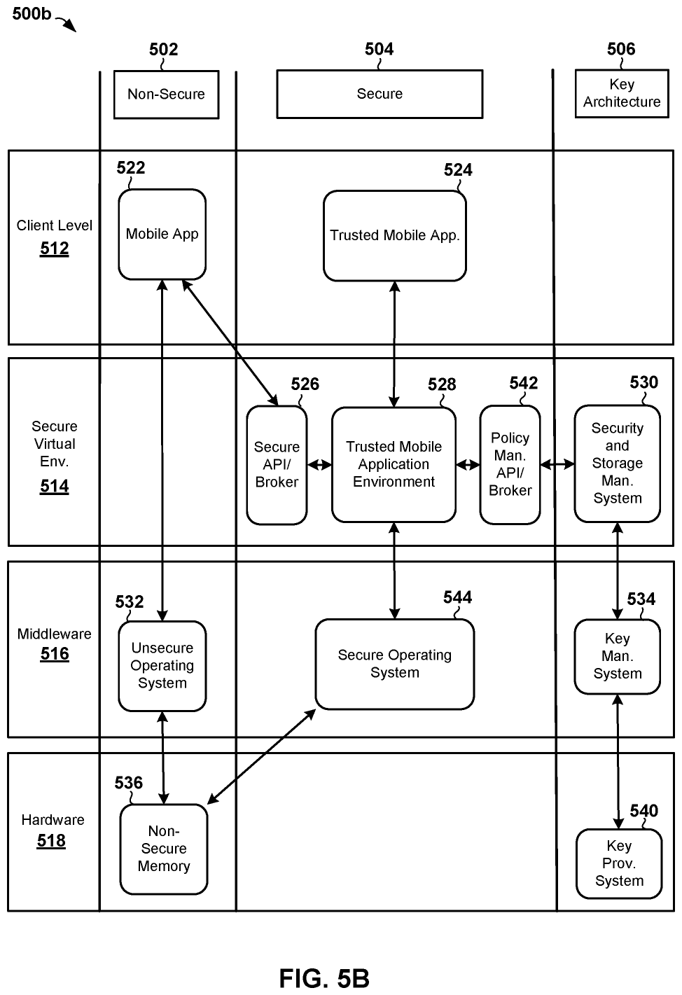

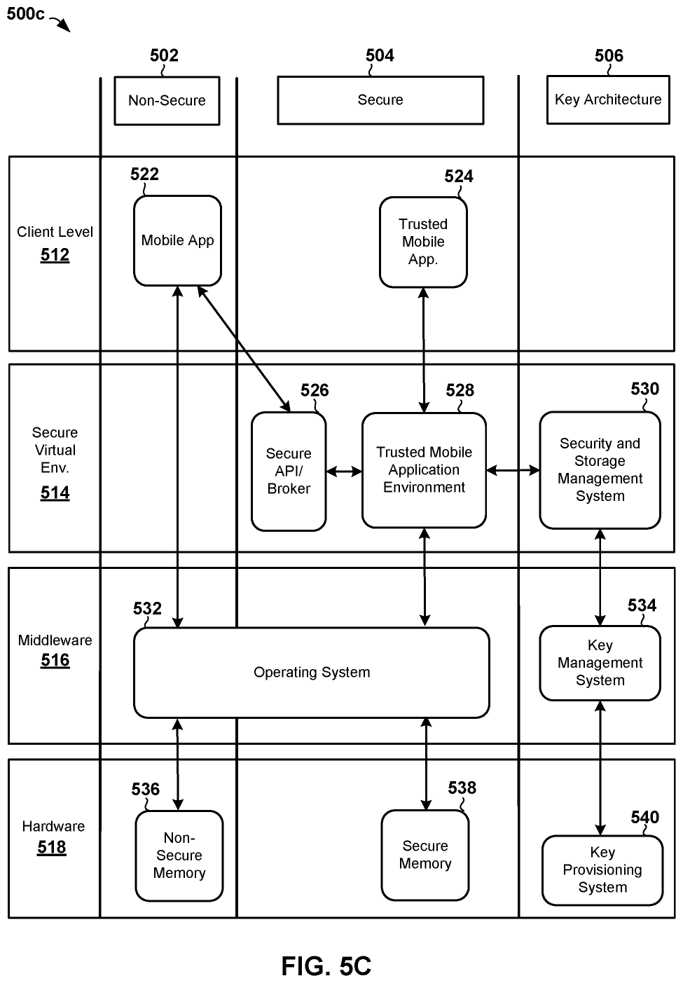

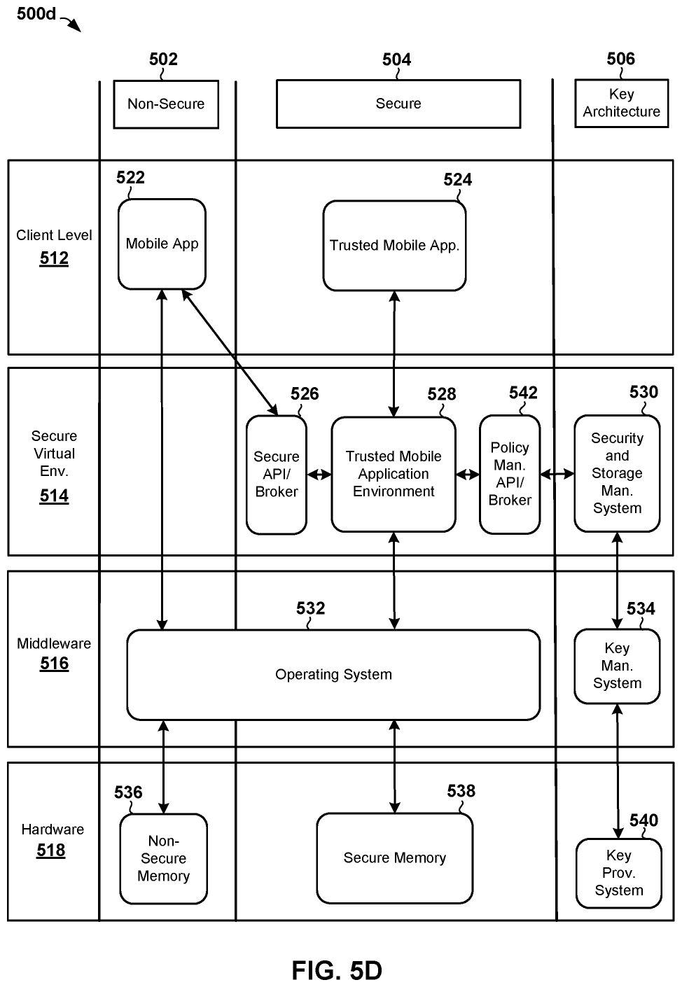

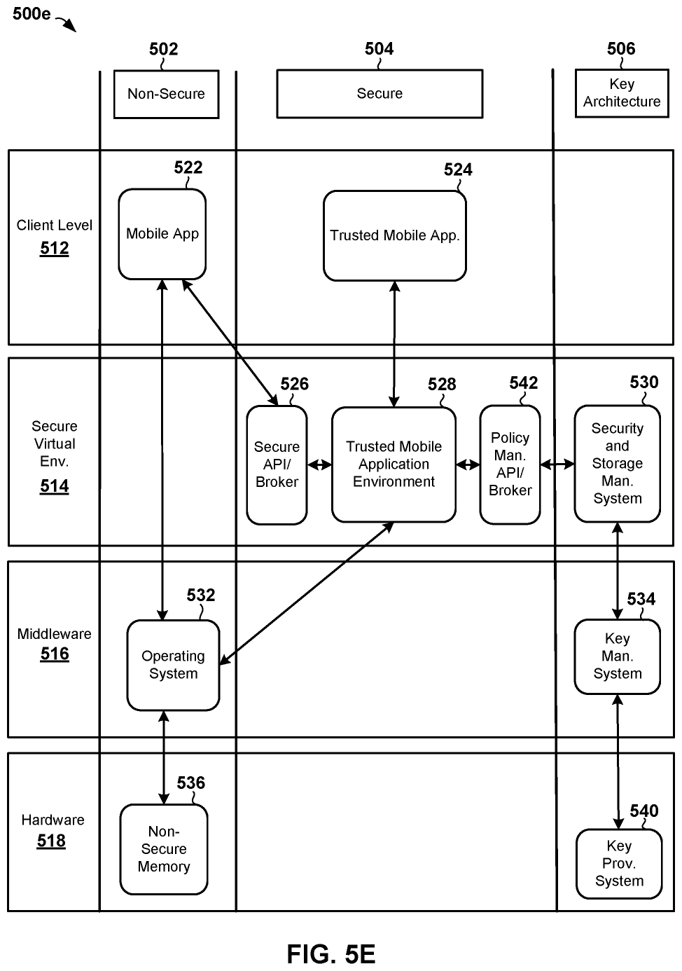

FIGS. 5A-5E illustrate example logical components and information flows in secure computing environments that could be configured to identify and respond to suspicious and non-benign reprogramming operations in accordance with the embodiments, including the embodiments discussed above with reference to FIGS. 1A-4.

Referring to FIG. 5A, the overall system architecture 500a may include three areas; a non-secure area 502, a secure area 504, and a key architecture 506. The non-secure area 502 represents unprotected areas in which security protocols are not applied, the secure area 504 represents protected areas in which security protocols are applied, and the key architecture area 506 represents the areas in which mobile device security keys operate. The non-secure area 502 includes a mobile application 522, a normal or unsecure operating system 532, and non-secure memory 536. The secure area 504 includes a trusted mobile application 524, a secure API/broker 526, a trusted mobile application environment 528, a secure operating system 544, and a secure memory 538. The key architecture 506 includes a security and storage management system 530, a key management system 534, and a key provisioning system 540.

The software levels of the system 500a may be broken down into a client level 512, a secure virtual environment 514, a middleware level 516, and a hardware level 518. Client level 512 software may include general mobile device software applications 522 and trusted mobile applications 524, which may be pre-authorized software provided by a third party (e.g., retailer) that is identified as complying with specific security and/or operability requirements.

The secure virtual area 514 may be a software level or run time environment established on a mobile device. The secure virtual environment 514 may contain a secure API/broker 526 that may act as a gate keeper for the secure virtual environment 514. For example, a user may attempt to access or modify the mobile application 522 stored in a non-secure area. In response, the secure API/broker 526 may determine whether the mobile application 522 (or its access/modification by the user) meets the security and operability requirements of secure virtual environment 514. If so, the secure API/broker 526 may allow the mobile application 522 to operate in the secure virtual environment 514, and may relay relevant information to and from the trusted mobile application environment 528, which is an area of the secure virtual environment 514 in which the authorized applications operate. The mobile application 522 may be restricted from further interactions with the secure virtual environment 514 if it ceases to meet the requirements of the secure API/broker 526.

The secure virtual environment 514 may include a security and storage management system 530 that interacts with the trusted mobile application environment 528 and the key management system 534 to provide necessary security and storage capability.

An unsecure operating system 532 may be provided on the mobile device in a non-secure area 502, and a non-secure memory 536 may be provided in a non-secure area 502. A mobile application 522 that does not meet the requirements of the secure API/broker 526 may only operate in the unsecure operating system 532 and may only write or read data to the non-secure memory 536.

Provided in the secure area 504 of the mobile device may be a secure operating system 544 and a secure memory 538. Trusted mobile applications 524 may be provided to the trusted mobile application environment 528. Trusted mobile applications 524 may be provided to the secure operating system 544 through the trusted mobile application environment 528. Only applications in the trusted mobile application environment 528 may interact with the secure operating system 544 and the secure memory 538. In the embodiment illustrated in FIG. 5A, the non-secure memory 536, the secure memory 538 and the key provisioning system 540 reside at the hardware level 518.

FIG. 5B illustrates another embodiment architecture 500b that includes functional components similar to those described with reference to FIG. 5A, and includes a policy manger broker 542 and a single memory 536 on the mobile device. In this embodiment, the secure operating system 544 and the unsecure operating system 532 both store and read data on the non-secure memory 536. Data in the secure virtual environment 514 may be stored in an encrypted form when not in use by the trusted mobile application environment 528. The continual application of encryption at the data level by the secure virtual environment 514 ensures that secure data may be stored in a non-secure memory 536 because the secure data itself will be encrypted at the data level.

FIGS. 5C-5E illustrate alternative embodiments of a secure virtual environment in which a mobile device is configured with a single operating system.

Referring to FIG. 5C, the overall system architecture 500c is similar to the embodiment discussed above with reference to FIG. 5A, but the operating system 532 is included in both the secure area 504 and non-secure area 502. The operating system 532 may interact with the secure virtual environment 532 through the trusted mobile application environment 528 and mobile applications 522 in a non-secure area 502. The operating system 532 may be configured such that a mobile application 522 that does not meet the requirements of the secure API/broker 526 may only function in a non-secure area 502 of the operating system 532 and may only write or read data to the non-secure memory 536. The operating system 532 may also operate in the secure area 504 of the mobile device and read and write data to a secure memory 538.

Trusted mobile applications 524, and mobile applications 522 that meet the requirements of the secure API/broker 526, may be provided to the operating system 544 through the trusted mobile application environment 528. Only applications in the trusted mobile application environment 528 interact with the secure memory 538 through the operating system 532.

FIG. 5D illustrates another embodiment system architecture 500d that includes functional components similar to those described above with reference to FIGS. 5B and 5C, with a single operating system 532 and a policy manager broker 542. The policy manager broker 542 may be in communication with the security and storage management system 530 and the trusted mobile application environment 528. Through either the trusted mobile application environment 528, or the security and storage management system 530, the policy manager broker 542 may receive policy updates from a retailer, lender or corporate entity.

The policy manager broker 542 may enable the retailer or lender to update security protocols, update operating restrictions, and perform various functions in the secure virtual environment 514 and the secure area 504 of the mobile device. The policy manager broker 542 may provide the retailer or lender with the ability to remotely update and control the trusted mobile application 524, secure virtual environment 514, and/or secure area 504 of the mobile device.

FIG. 5E illustrates another embodiment of the system architecture 500e that includes functional components similar to those described above with respect to FIG. 5D, but with a single memory 536 on the mobile device. Additionally, in this embodiment the operating system 532 resides entirely in the non-secure area 502. In this embodiment data from the trusted mobile application environment 528 and all other data passes to a single non-secure memory 536. Data in the secure virtual environment 514 may be stored in an encrypted form when not in use by the trusted mobile application environment 528. The continual application of encryption at the data level by the secure virtual environment 514 ensures that secure data may be stored in a non-secure memory 536 because the secure data itself will be encrypted at the data level.

Some embodiments may include a method of operating a mobile device, which may include monitoring, by a processor in the mobile device, systems and subsystems in the mobile device to detect a flashing command from a flashing tool or source, generating, a flashing request value in response to detecting the flashing command, storing the flashing request value in a secure area of the mobile device, sending the flashing request value to the flashing tool or source, sending a notification message to a server computing device, receiving a notification-response message that includes a secured flashing request value from the server computing device, determining whether the secured flashing request value match the flashing request value stored in the secure area of the mobile device, performing the detected flashing command in response to determining that the secured flashing request value matches the flashing request value stored in the secure area of the mobile device, and ignoring or discarding the detected flashing command in response to determining that the secured flashing request value does not match the flashing request value stored in the secure area of the mobile device.

In some embodiments, the method may further include receiving, by a processor in a server computing device, a notification message from a mobile device indicating that a flashing command from a flashing tool or source has been detected in the mobile device, receiving a flashing request value from a flashing tool or source, determining whether the flashing tool or source is an authorized source, generating a secured flashing request value based on the flashing request value in response to determining that the flashing tool or source is an authorized source, and sending the secured flashing request value to the mobile device in response to determining that the flashing tool or source is an authorized source. In some embodiments, a determination of whether the flashing tool or source is an authorized source may not be made, and instead, sending the secured flashing request value to the mobile device in response to a test result.

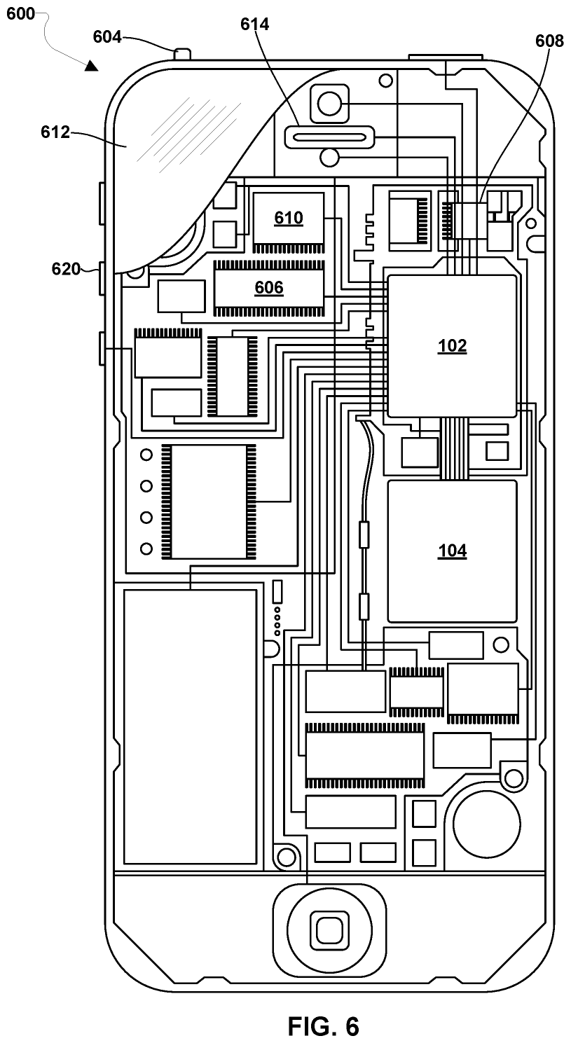

The various embodiments (e.g., mobile device 142, 400, etc.) may be implemented on a variety of mobile devices, an example of which in the form of a smartphone is illustrated in FIG. 6. A smartphone 600 may include a first SOC 102 (e.g., a SOC-CPU) coupled to a second SOC 104 (e.g., a 5G capable SOC). The first and second SOCs 102, 104 may be coupled to internal memory 606, a display 612, and to a speaker 614. Additionally, the smartphone 600 may include an antenna 604 for sending and receiving electromagnetic radiation that may be connected to a wireless data link and/or cellular telephone transceiver 608 coupled to one or more processors in the first and/or second SOCs 102, 104. Smartphones 600 typically also include menu selection buttons or rocker switches 620 for receiving user inputs.

A typical smartphone 600 also includes a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second SOCs 102, 104, wireless transceiver 608 and CODEC 610 may include a digital signal processor (DSP) circuit (not shown separately).

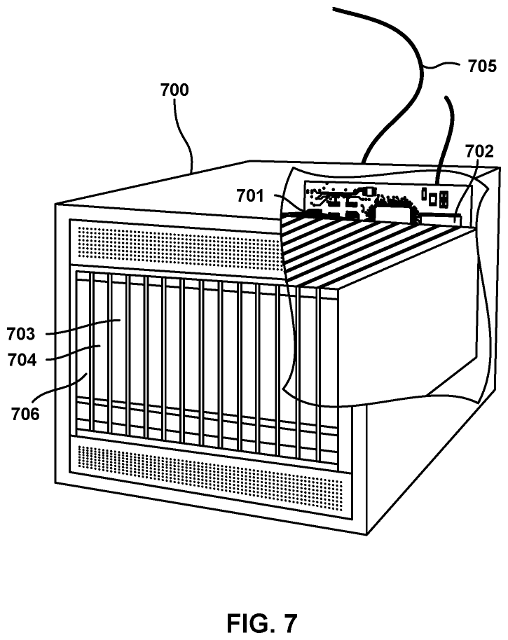

Various embodiments (e.g., trusted entity server 158 illustrated in FIG. 1C, etc.) may be implemented on any of a variety of commercially available computing devices, such as a server 700 an example of which is illustrated in FIG. 7. Such a server 700 typically includes a processor 701 coupled to volatile memory 702 and a large capacity nonvolatile memory, such as a disk drive 703. The server 700 may also include a floppy disc drive, compact disc (CD) or DVD disc drive 704 coupled to the processor 701. The server 700 may also include network access ports 706 coupled to the processor 701 for establishing data connections with a network 705, such as a local area network coupled to other operator network computers and servers.

The processors may be any programmable microprocessor, microcomputer or multiple processor chip or chips that may be configured by software instructions (applications) to perform a variety of functions, including the functions of the various embodiments described in this application. In some mobile devices, multiple processors may be provided, such as one processor dedicated to wireless communication functions and one processor dedicated to running other applications. Typically, software applications may be stored in the internal memory 606 before they are accessed and loaded into the processor. The processor may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments may be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, functional components, functionality components, circuits, and algorithm operations described in connection with the embodiments disclosed herein may be implemented as electronic hardware, computer software, or combinations of both. To clearly illustrate this interchangeability of hardware and software, various illustrative components, blocks, functional components, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement the various illustrative logics, logical blocks, functional components, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of operating a mobile device, comprising:
collecting, by a processor in the mobile device, flashing information;
storing, by the processor, the collected flashing information in a secure area of the mobile device;
evaluating, by the processor on each reboot of the mobile device, flashing information stored in the secure area of the mobile device and information stored in a secured action-command information structure to generate an evaluation result;
selectively setting, by the processor based on the evaluation result, a tampered flag or bit in the secure area of the mobile device; and
performing, by the processor, a responsive actuation operation in response to determining that the tampered flag or bit has been set.

2. The method of claim 1, wherein collecting flashing information comprises at least one or more of:
collecting flashing information in response to detecting an erase command in a boot sequence;
collecting flashing information in response to detecting a program command in the boot sequence;
collecting flashing information in response to detecting a software update image from an over-the-air update server; or
collecting flashing information in response to determining that a primary bootloader (PBL) of a secure boot feature of the mobile device failed to verify a secondary bootloader (SBL) and the mobile device has commenced entering emergency download mode (EDL).

3. The method of claim 1, wherein collecting flashing information comprises collecting at least one or more of:
flashing source information identifying a flashing source;
information identifying a command issued by the flashing source;
information identifying an action performed by the mobile device in response to the command issued by the flashing source;
a result generated in the mobile device from performance of the command issued by the flashing source; or
a number of times that flashing operations have been detected on the mobile device over a period of time.

4. The method of claim 1,
wherein the secured action-command information structure stores values hashed with an International Mobile Equipment Identity (IMEI) number or a hardware key (HW key) in an instruction memory or another secure area of the mobile device; and
wherein evaluating, on each reboot of the mobile device, flashing information stored in the secure area of the mobile device and information stored in the secured action-command information structure to generate the evaluation result comprises comparing flashing information stored in the secure area of the mobile device with a value hashed with the IMEI number or the HW key in the instruction memory or other secure area of the mobile device.

5. The method of claim 1, wherein evaluating, on each reboot of the mobile device, flashing information stored in the secure area of the mobile device and information stored in the secured action-command information structure to generate the evaluation result comprises:
comparing, on each reboot, flashing information stored in the secure area with the information stored in the secured action-command information structure to determine whether flashing operations completed most recently were non-benign.

6. The method of claim 1, wherein storing the collected flashing information in the secure area of the mobile device comprises:
incrementing a flashing counter in the secure area of the mobile device that identifies a number of times that flashing operations have been detected on the mobile device.

7. The method of claim 1, further comprising:
determining, by the processor based on the evaluation result, a probability value that identifies a likelihood that a detected flashing operation is an unauthorized flashing operation; and
determining, by the processor, whether the probability value exceeds a threshold value,
wherein selectively setting the tampered flag or bit in the secure area of the mobile device comprises setting, by the processor, the tampered flag or bit in the secure area of the mobile device in response to determining that the probability value exceeds the threshold value.

8. The method of claim 7, wherein determining the probability value that identifies the likelihood that the detected flashing operation is the unauthorized flashing operation comprises determining, based on the evaluation result, whether an International Mobile Equipment Identity (IMEI) number, subsidy lock or security critical information was erased from the mobile device.

9. The method of claim 8, further comprising setting the probability value greater than the threshold value in response to determining that the IMEI number, subsidy lock or security critical information was erased from the mobile device.

10. The method of claim 7, wherein determining the probability value that identifies the likelihood that the detected flashing operation is the unauthorized flashing operation comprises:
determining the probability value based on a number of times that flashing operations have been detected on the mobile device.

11. The method of claim 1, wherein storing the collected flashing information in the secure area of the mobile device comprises storing flash control information in the secure area:
during a first bootup of the mobile device;
when secure boot is enabled; or
during the provisioning of secure areas of the mobile device.

12. A mobile device, comprising:
a processor configured with processor-executable software instructions to:
collect flashing information;
store the collected flashing information in a secure area of the mobile device;
evaluate, on each reboot of the mobile device, flashing information stored in the secure area of the mobile device and information stored in a secured action-command information structure to generate an evaluation result;
selectively set, based on the evaluation result, a tampered flag or bit in the secure area of the mobile device; and
perform a responsive actuation operation in response to determining that the tampered flag or bit has been set.

13. The mobile device of claim 12, wherein the processor is configured with processor-executable software instructions to collect flashing information by one or more of:
collecting flashing information in response to detecting an erase command in a boot sequence;
collecting flashing information in response to detecting a program command in the boot sequence;
collecting flashing information in response to detecting a software update image from an over-the-air update server;
collecting flashing information in response to determining that a primary bootloader (PBL) of a secure boot feature of the mobile device failed to verify a secondary bootloader (SBL) and the mobile device has commenced entering emergency download mode (EDL);
collecting flashing source information identifying a flashing source;
collecting information identifying a command issued by the flashing source;
collecting information identifying an action performed by the mobile device in response to the command issued by the flashing source;
collecting a result generated in the mobile device from performance of the command issued by the flashing source; or
collecting a number of times that flashing operations have been detected on the mobile device over a period of time.

14. The mobile device of claim 12, wherein the secured action-command information structure stores values hashed with an International Mobile Equipment Identity (IMEI) number or a hardware key (HW key) in an instruction memory or another secure area of the mobile device; and
wherein the processor is configured with processor-executable software instructions to evaluate, on each reboot of the mobile device, flashing information stored in the secure area of the mobile device and information stored in the secured action-command information structure to generate the evaluation result by comparing flashing information stored in the secure area of the mobile device with a value hashed with the IMEI number or the HW key in the instruction memory or other secure area of the mobile device.

15. The mobile device of claim 12, wherein the processor is configured with processor-executable software instructions to evaluate, on each reboot of the mobile device, flashing information stored in the secure area of the mobile device and information stored in the secured action-command information structure to generate the evaluation result by:
comparing, on each reboot, flashing information stored in the secure area with the information stored in the secured action-command information structure to determine whether flashing operations completed most recently were non-benign.

16. The mobile device of claim 12, the processor is configured with processor-executable software instructions to store the collected flashing information in the secure area of the mobile device by:
incrementing a flashing counter in the secure area of the mobile device that identifies a number of times that flashing operations have been detected on the mobile device.

17. The mobile device of claim 12,
wherein the processor is further configured with processor-executable software instructions to:
determine, based on the evaluation result, a probability value that identifies a likelihood that a detected flashing operation is an unauthorized flashing operation; and
determine whether the probability value exceeds a threshold value, and
wherein the processor is configured with processor-executable software instructions to selectively set the tampered flag or bit in the secure area of the mobile device by setting the tampered flag or bit in the secure area of the mobile device in response to determining that the probability value exceeds the threshold value.

18. The mobile device of claim 17, wherein the processor is configured with processor-executable software instructions to:
determine the probability value that identifies the likelihood that the detected flashing operation is the unauthorized flashing operation by determining, based on the evaluation result, whether an International Mobile Equipment Identity (IMEI) number, subsidy lock or security critical information was erased from the mobile device; and
set the probability value greater than the threshold value in response to determining that the IMEI number, subsidy lock or security critical information was erased from the mobile device.

19. The mobile device of claim 17, wherein the processor is configured with processor-executable software instructions to determine the probability value that identifies the likelihood that the detected flashing operation is the unauthorized flashing operation by determining the probability value based on a number of times that flashing operations have been detected on the mobile device.

20. The mobile device of claim 12, wherein the processor is configured with processor-executable software instructions to store the collected flashing information in the secure area of the mobile device by storing flash control information in the secure area:
during a first bootup of the mobile device;
when secure boot is enabled; or
during the provisioning of secure areas of the mobile device.

21. A non-transitory computer readable storage medium having stored thereon processor-executable software instructions configured to cause a processor in a mobile device to perform operations comprising:
collecting flashing information;
storing the collected flashing information in a secure area of the mobile device;
evaluating, on each reboot of the mobile device, flashing information stored in the secure area of the mobile device and information stored in a secured action-command information structure to generate an evaluation result;
selectively setting, based on the evaluation result, a tampered flag or bit in the secure area of the mobile device; and
performing a responsive actuation operation in response to determining that the tampered flag or bit has been set.

22. The non-transitory computer readable storage medium of claim 21, wherein the stored processor-executable software instructions are configured to cause a processor to perform operations such that collecting flashing information comprises at least one or more of:
collecting flashing information in response to detecting an erase command in a boot sequence;
collecting flashing information in response to detecting a program command in the boot sequence;
collecting flashing information in response to detecting a software update image from an over-the-air update server;
collecting flashing information in response to determining that a primary bootloader (PBL) of a secure boot feature of the mobile device failed to verify a secondary bootloader (SBL) and the mobile device has commenced entering emergency download mode (EDL);
collecting flashing source information identifying a flashing source;
collecting information identifying a command issued by the flashing source;
collecting information identifying an action performed by the mobile device in response to the command issued by the flashing source;
collecting a result generated in the mobile device from performance of the command issued by the flashing source; or
collecting a number of times that flashing operations have been detected on the mobile device over a period of time.

23. The non-transitory computer readable storage medium of claim 21, wherein the stored processor-executable software instructions are configured to cause a processor to perform operations such that:
the secured action-command information structure stores values hashed with an International Mobile Equipment Identity (IMEI) number or a hardware key (HW key) in an instruction memory or another secure area of the mobile device; and
evaluating, on each reboot of the mobile device, flashing information stored in the secure area of the mobile device and information stored in the secured action-command information structure to generate the evaluation result comprises comparing flashing information stored in the secure area of the mobile device with a value hashed with the IMEI number or the HW key in the instruction memory or other secure area of the mobile device.

24. The non-transitory computer readable storage medium of claim 21, wherein the stored processor-executable software instructions are configured to cause a processor to perform operations such that evaluating, on each reboot of the mobile device, flashing information stored in the secure area of the mobile device and information stored in the secured action-command information structure to generate the evaluation result comprises:
comparing, on each reboot, flashing information stored in the secure area with the information stored in the secured action-command information structure to determine whether flashing operations completed most recently were non-benign.

25. The non-transitory computer readable storage medium of claim 21, wherein the stored processor-executable software instructions are configured to cause a processor to perform operations such that storing the collected flashing information in the secure area of the mobile device comprises:
incrementing a flashing counter in the secure area of the mobile device that identifies a number of times that flashing operations have been detected on the mobile device.

26. The non-transitory computer readable storage medium of claim 21, wherein:
the stored processor-executable software instructions are configured to cause a processor to perform operations further comprising:
determining, based on the evaluation result, a probability value that identifies a likelihood that a detected flashing operation is an unauthorized flashing operation; and
determining whether the probability value exceeds a threshold value; and
the stored processor-executable software instructions are configured to cause a processor to perform operations such that selectively setting the tampered flag or bit in the secure area of the mobile device comprises setting, by the processor, the tampered flag or bit in the secure area of the mobile device in response to determining that the probability value exceeds the threshold value.

27. The non-transitory computer readable storage medium of claim 26, wherein:
the stored processor-executable software instructions are configured to cause a processor to perform operations such that determining the probability value that identifies the likelihood that the detected flashing operation is the unauthorized flashing operation comprises determining, based on the evaluation result, whether an International Mobile Equipment Identity (IMEI) number, subsidy lock or security critical information was erased from the mobile device; and
the stored processor-executable software instructions are configured to cause a processor to perform operations further comprising:
setting the probability value greater than the threshold value in response to determining that the IMEI number, subsidy lock or security critical information was erased from the mobile device.

28. The non-transitory computer readable storage medium of claim 26, wherein the stored processor-executable software instructions are configured to cause a processor to perform operations such that determining the probability value that identifies the likelihood that the detected flashing operation is the unauthorized flashing operation comprises determining the probability value based on a number of times that flashing operations have been detected on the mobile device.

29. The non-transitory computer readable storage medium of claim 21, wherein the stored processor-executable software instructions are configured to cause a processor to perform operations such that storing the collected flashing information in the secure area of the mobile device comprises storing flash control information in the secure area:
during a first bootup of the mobile device;
when secure boot is enabled; or
during the provisioning of secure areas of the mobile device.

30. A mobile device, comprising:
means for collecting flashing information;
means for storing the collected flashing information in a secure area of the mobile device;
means for evaluating, on each reboot of the mobile device, flashing information stored in the secure area of the mobile device and information stored in a secured action-command information structure to generate an evaluation result;
means for selectively setting, based on the evaluation result, a tampered flag or bit in the secure area of the mobile device; and
means for performing a responsive actuation operation in response to determining that the tampered flag or bit has been set.
